(19) United States
(12) Patent Application Publication
(10) Pub. No.: US 2016/0319381 A1
(43) Pub. Date: Nov. 3, 2016

(54) METHOD FOR REDUCING CO2 EMISSIONS IN THE OPERATION OF A METALLURGICAL PLANT

(71) Applicant: ThyssenKrupp AG, Essen (DE)

(72) Inventors: Reinhold Achatz, Essen (DE); Jens Wagner, Frankfurt a.M. (DE); Markus Oles, Hattingen (DE); Peter Schmöle, Dortmund (DE); Ralph Kleinschmidt, Mülheim a.d.Ruhr (DE); Christoph Meißner, Dortmund (DE); Denis Krotov, Dortmund (DE); Olaf von Morstein, Essen (DE)

(21) Appl. No.: 15/102,760

(22) PCT Filed: Dec. 11, 2014
(86) PCT No.: PCT/EP2014/003314

§ 371 Date: Jun. 8, 2016

(30) Foreign Application Priority Data
Dec. 12, 2013 (DE) 10 2013 113 942.6

(51) Int. Cl. C21B 5/06; C21C 5/38; C25B 1/04; C01B 3/32; C01B 3/12; C21B 7/00; C01B 3/02

(52) U.S. Cl. CPC C21B 5/06; C21B 7/002; C21C 5/38; C01B 3/025; C01B 3/32; C01B 3/12; C25B 1/04; C01B 2203/0283; C01B 2203/025; C01B 2203/0205; C01B 2203/1205

(57) ABSTRACT

The invention relates to a method for reducing CO₂ emissions in the operation of a metallurgical plant which comprises at least one blast furnace for producing crude iron and a converter steel mill for producing crude steel. According to the invention, at least a partial amount of the blast-furnace top gas that occurs in the blast furnace in the production of crude iron and/or a partial amount of the converter gas that occurs in the production of crude steel is taken for producing syngas that is used for producing chemical products. At the same time, the energy demand of the metallurgical plant is at least partly covered by using electricity that is obtained from renewable energy.

### CROSS-REFERENCE TO RELATED APPLICATIONS

This application is the national phase of, and claims priority to, International Patent Application No. PCT/EP2014/003314, filed Dec. 11, 2014, which designated the U.S. and which claims priority to German Patent Application Number DE 10 2013 113 942.6, filed Dec. 12, 2013. These applications are each incorporated by reference herein in their entireties.

### BACKGROUND

1. Field of the Invention

The invention relates to a method for reducing CO₂ emissions in the operation of a metallurgical plant which comprises at least one blast furnace for producing crude iron and a converter steel mill for producing crude steel.

2. Description of the Related Art

Crude iron is obtained in the blast furnace from iron ores, additives and also coke and other reducing agents such as coal, oil, gas, biomasses, recycled waste plastics or other substances containing carbon and/or hydrogen. CO, CO₂, hydrogen and water vapour inevitably occur as products of the reduction reactions. Apart from the aforementioned constituents, a blast-furnace top gas drawn off from the blast-furnace process often has a high content of nitrogen. The amount of gas and the composition of the blast-furnace top gas are dependent on the feedstock and the operating mode and are subject to fluctuations. Typically, however, blast-furnace top gas contains 35 to 60% by volume N₂, 20 to 30% by volume CO, 20 to 30% by volume CO₂ and 2 to 15% by volume H₂. Around 30 to 40% of the blast-furnace top gas produced in the production of the crude iron is generally used for heating up the hot air for the blast-furnace process in air heaters; the remaining amount of top gas may be used in other areas of the mill for heating purposes or for electricity generation.

In the converter steel mill, which is arranged downstream of the blast-furnace process, crude iron is converted into crude steel. By blowing oxygen onto liquid crude iron, troublesome impurities such as carbon, silicon, sulphur and phosphorus are removed. Since the oxidation processes cause an intense development of heat, scrap is often added in amounts of up to 25% with respect to the crude iron as a coolant. Furthermore, lime is added for forming slag and an alloying agent is added. A converter gas that has a high content of CO and also contains nitrogen, hydrogen and CO₂ is drawn off from the steel converter. A typical converter gas composition has 50 to 70% by volume CO, 10 to 20% by volume N₂, about 15% by volume CO₂ and about 2% by volume H₂. The converter gas is either burned off or, in the case of modern steel works, captured and passed on to be used for providing energy.

The method of producing crude iron in the blast furnace and producing crude steel in a converter steel mill inevitably leads to unavoidable process-related CO₂ emissions. After metallurgical work in the blast furnace has made use of the raw material content and after the residual contents that are unavoidable for thermodynamic reasons, of carbon monoxide in particular, have been used for providing energy, eventually all of the carbon introduced is emitted as carbon dioxide. The aim is to reduce the emission of the climatically harmful CO₂ gas. Use of pre-reduced or metallic material is possible, but only yields advantages if the CO₂ emissions that occur in the production of these substances are lower. The use of renewable energy sources, for example charcoal or rapeseed oil, as carbon-bearing substances for the blast-furnace process is only conducive to achieving the aim if at the same time the CO₂ consumption of the crops during growth is counteracted. P. Schmöle (Stahl and Eisen [steel and iron] 124 2004, No. 5, pages 27 to 32), points out that, when blowing internal coupled products of a plant, such as for example coke-oven gas, into the tuyere of blast furnaces, lower CO₂ emissions can be realized if, assuming that a metallurgical plant has a closed energy balance, the energy of the coke gas used in the blast furnace is compensated by buying in electricity from renewable energy sources.

According to the prevailing teaching, an improvement in the CO₂ balance in the production of crude iron and crude steel presupposes changes to the method that concern the operation of the blast furnace. These include for example nitrogen-free operation of the blast furnace, in which cold oxygen is blown in at the tuyere level instead of hot air, and most of the top gas is fed to a CO₂ scrubbing. It has also been proposed to heat the blast furnace with plasma. The process of the plasma-heated blast furnace requires neither hot air nor oxygen, nor any additional substitute reducing agent. However, the introduction of new blast-furnace methods is a serious intervention in the tried-and-tested technology of crude iron and crude steel production and entails considerable risks.

### SUMMARY

Against this background, the invention is based on the object of improving the CO₂ balance of a metallurgical plant that has a conventionally operated blast furnace for producing crude iron and a conventionally operated converter steel mill

### DETAILED DESCRIPTION

According to the invention, at least a partial amount of the blast-furnace top gas that occurs in the blast furnace in the production of crude iron and/or a partial amount of the converter gas that occurs in the production of crude steel is taken for producing syngas that is used for producing chemical products. When the raw gases are used for producing syngas, the energy demand of the metallurgical plant is not always covered, and according to the invention it is at least partly covered by using electricity that is obtained from renewable energy. Using part of the raw gases that occur in the production of crude iron and the production of crude steel for producing chemical products and using electricity from renewable energy to equalize the energy balance are in a combinational relationship and bring about a reduction in the emission of CO₂ in the operation of the metallurgical plant, since carbon is bound in chemical products and is not separated out in the form of CO₂.

If the metallurgical plant is operated in combination with a coke-oven plant, at least a partial amount of a coke-oven gas that occurs in the coke-oven plant is also expediently used for producing syngas.

The potential of the method according to the invention for reducing CO₂ emissions is great, since, in a metallurgical plant that is operated in combination with a coking plant, only approximately 40 to 50% of the raw gases that occur as blast-furnace top gas, converter gas and coke-oven gas are used for chemical engineering processes and 50 to 60% of the gases produced can be put to other uses. In practice, this fraction has been mainly used for electricity generation. If, on the basis of the method according to the invention, this fraction is used for producing chemical products by way of syngas production, and the energy demand which is then not met is covered by using electricity from renewable energy, a considerable reduction in the CO₂ emissions of a metallurgical plant is possible.

It is provided within the teaching according to the invention that 1% to 60%, preferably a proportion of 10 to 60%, of the raw gases that occur as blast-furnace top gas and converter gas, or as blast-furnace top gas, converter gas and coke-oven gas, is used for producing syngas.

The production of syngas expediently comprises a gas-cleaning operation and a gas-conditioning operation, it being possible for example to use for the gas conditioning a steam-reforming operation with water vapour and/or a partial oxidation with air or oxygen and/or a water-gas-shift reaction for the conversion of CO. The conditioning steps may be used individually or in combination. The syngas produced by the method according to the invention is a gas mixture that is used for synthesis. The term “syngas” covers for example gas mixtures of N₂ and H₂ for ammonia synthesis and in particular gas mixtures that mainly contain CO and H₂ or CO₂ and H₂ or CO, CO₂ and H₂. From the syngases, chemical products that respectively contain the components of the reactant can be produced in a chemical plant. Chemical products may be for example ammonia or methanol or else other hydrocarbon compounds.

For producing ammonia, for example, a syngas that contains nitrogen and hydrogen in the correct ratio must be provided. The nitrogen can be obtained from blast-furnace top gas. Blast-furnace top gas or converter gas may be used in particular as the hydrogen source, hydrogen being produced by conversion of the CO fraction by a water-gas-shift reaction (CO+H₂O⇄CO₂+H₂). A mixture of coke-oven gas and blast-furnace top gas or a mixed gas comprising coke-oven gas, converter gas and blast-furnace top gas may also be used for producing a syngas for ammonia synthesis. For producing hydrocarbon compounds, for example methanol, it is necessary to provide a syngas consisting substantially of CO and/or CO₂ and H₂ that contains the components carbon monoxide and/or carbon dioxide and hydrogen in the correct ratio. The ratio is often described by the module (H₂−CO₂)/(CO+CO₂). The hydrogen may be produced for example by conversion of the CO fraction in the blast-furnace top gas by a water-gas-shift reaction. Converter gas may be used for providing CO. Blast-furnace top gas and/or converter gas may serve as a source of CO₂. A mixed gas comprising coke-oven gas and converter gas or a mixed gas comprising coke-oven gas, converter gas and blast-furnace top gas is suitable for producing hydrocarbon compounds.

Within the scope of the invention, a biotechnological plant may also be used instead of a chemical plant for producing chemical products from syngas. The plant concerned is a plant for the fermentation of syngas. Syngas should be understood in this case as including mixtures of CO and H₂, preferably with a high proportion of CO, with which alcohols, acetone or organic acids can be produced. However, when a biochemical process is used, the hydrogen originates substantially from the water that is used as a medium in the fermentation. Converter gas is preferably used as a source for CO. The use of blast-furnace top gas or a mixed gas comprising converter gas and blast-furnace top gas is likewise possible. By contrast, the use of coke-oven gas is unfavourable for a biotechnological process. Consequently, products that contain carbon from the CO fraction of the raw gases that occur in a metallurgical plant and hydrogen from the water used in a fermentation process can be produced by means of a biotechnological process.

A further refinement of the method according to the invention provides that syngas is enriched with hydrogen that is produced by electrolysis of water, electricity from renewable energy likewise being used for the electrolysis of water.

Furthermore, the metallurgical plant may be operated in an electrical network with an energy storage which is fed with electricity from renewable energy and gives off the stored energy again at a later time to electrical loads of the metallurgical plant.

Externally obtained electricity, which is at least partially and preferably completely obtained from renewable energy and originates for example from wind turbine generator plants, solar plants, hydroelectric power-generating plants and the like, is used to cover the electricity demand of the metallurgical plant. It should not be ruled out that the metallurgical plant is used in combination with a power-generating plant that is designed as a gas-turbine power-generating plant or gas-turbine and steam-turbine power-generating plant and is operated with part of the gases that occur in the metallurgical plant as blast-furnace top gas, converter gas or coke-oven gas. The plant complex with the inclusion of the power-generating plant is designed in such a way that the power-generating plant can be used in standby mode and at least at certain times is switched off. The power-generating plant can be used when the chemical plant or a biotechnological plant is out of operation or the energy originating from regenerative sources or stored in an energy storage is not sufficient for a time for covering the energy demand of the metallurgical plant. In order that the plant complex has available the amount of electricity required for producing crude iron and producing crude steel, at times of sufficient availability of the renewable energy electrical energy is stored in the energy storage. If the renewable energy is not externally available in a sufficient amount at acceptable prices, the required electricity is taken from the energy storage. The energy storage may be formed as a chemical or electrochemical storage.

1.-9. (canceled)

10. A method for reducing CO₂ emissions in the operation of a metallurgical plant which comprises at least one blast furnace for producing crude iron and a converter steel mill for producing crude steel, the method comprising:
a) producing syngas from a partial amount of the blast-furnace top gas that occurs in the blast furnace in the production of pig iron and a partial amount of the converter gas that occurs in the production of crude steel, the syngas being used for producing chemical products, wherein 1% to 60% of the raw gases that occur as blast-furnace top gas and converter gas are used for producing the syngas; and
b) covering the energy demand of the metallurgical plant at least partly by using electricity that is obtained from renewable energy.

11. The method according to claim 10, wherein 10% to 60% of the raw gases that occur as blast-furnace top gas and converter gas are used for producing syngas.

12. The method according to claim 10, wherein the metallurgical plant is operated in combination with a coke-oven plant, and wherein at least a partial amount of a coke-oven gas that occurs in the coke-oven plant is used for producing syngas.

13. The method according to claim 10, wherein 1% to 60% of the raw gases that occur as blast-furnace top gas, converter gas and coke-oven gas are used for producing syngas.

14. The method according to claim 13, wherein 10% to 60% of the raw gases that occur as blast-furnace top gas, converter gas and coke-oven gas are used for producing syngas.

15. The method according to claim 10, wherein the production of syngas comprises a gas-cleaning operation and a gas-conditioning operation.

16. The method according to claim 13, wherein a steam-reforming operation with water vapour and/or a partial oxidation with air or oxygen and/or a water-gas-shift reaction is used for the gas conditioning.

17. The method according to claim 10, wherein a syngas used for the production of chemical products in a biotechnological plant is produced from converter gas or blast-furnace top gas or a mixed gas comprising converter gas and blast-furnace top gas.

18. The method according to claim 10, wherein the syngas is enriched with hydrogen that is produced by electrolysis of water, and wherein electricity from renewable energy is used for the electrolysis of water.

19. The method according to claim 10, wherein the metallurgical plant is operated in an electrical network with an energy storage, which is fed with electricity from renewable energy and gives off the stored energy again at a later time to one of electrical loads of the metallurgical plant and the electrolysis of water.
